(19) United States
(12) Patent Application Publication
(10) Pub. No.: US 2023/0264593 A1
(43) Pub. Date: Aug. 24, 2023

(54) SMART ELECTRIC VEHICLE CHARGING SYSTEM AND METHOD FOR SITUATIONAL MONITORING AND ALERTING

(71) Applicant: AMPLIFY CLEANTECH SOLUTIONS PRIVATE LIMITED, Bengaluru (IN)

(72) Inventor: Krishna Karthik Jasti, Hyderabad (IN)

(21) Appl. No.: 17/766,783

(22) PCT Filed: Oct. 8, 2020
(86) PCT No.: PCT/IB2020/059447

§ 371 Date: Apr. 6, 2022

(30) Foreign Application Priority Data
Oct. 11, 2019 (IN) 201941041218

(51) Int. Cl. B60L 53/65; B60L 53/62; B60L 53/68; B60L 53/66

(52) U.S. Cl. CPC B60L 53/65; B60L 53/62; B60L 53/68; B60L 53/66; B60L 2250/16

(57) ABSTRACT

A smart electric vehicle charging system and method for situational monitoring and alerting are disclosed. The system includes a registration subsystem configured to register one or more users on a platform, a slot availability checking subsystem configured to check an availability of at least one charging slot for the one or more users using one or more sensors upon registration of the one or more users on the platform, a slot booking subsystem configured to enable the one or more users to reserve a charging slot for an electric vehicle based on the availability of the at least one charging slot, an analysis subsystem configured to analyse data associated with one of an image capturing device or a measuring device using an analysis technique, a controlling subsystem configured to control one or more parameters associated with the electric vehicle charging station by a management unit on a server.

This International Application claims priority from a Patent Application filed in India having Patent Application No. 201941041218, filed on Oct. 11, 2019, and titled “SMART ELECTRIC VEHICLE CHARGING SYSTEM AND METHOD FOR SITUATIONAL MONITORING AND ALERTING”.

### FIELD OF INVENTION

Embodiments of a present disclosure relate to an electric vehicle, and more particularly to a smart electric vehicle charging system and method for situational monitoring and alerting.

### BACKGROUND

An electric vehicle is a category of vehicles which uses one or more electric motors or one or more traction motors for propulsion. The electric vehicle is powered by electricity which almost eliminates consumption of fossil fuels which are non-renewable in nature. An electric vehicle charging station, also called EV charging station, electric recharging point, charging point, charge point, ECS (electronic charging station), and EVSE (electric vehicle supply equipment), is an element in an infrastructure that supplies electric energy for recharging of plug-in electric vehicle including electric cars, neighbourhood electric vehicles and plug-in hybrids.

Various mobile applications help electric vehicle drivers to locate and identify the availability of the electric vehicle charging station. However, such mobile applications are unable to provide information of already parked electric vehicles which affects planning and schedule of the electric vehicle driver. Moreover, checking the parking of unauthorized or non-electric vehicle in front of public charging stations requires human intervention which is a time-consuming process and obtains inaccurate results.

Also, the electric vehicle drivers need to perform manual verification such as tap a RFID card, scan a QR code, use an app or call a number for initiating the charging process. Further, the electric vehicle driver is not sure if the charging gun has been plugged in properly or not which results in wastage of a lot of time if the charging gun is not fully plugged in properly. Furthermore, the electric vehicle driver is unaware about the sudden increased or decreased charging rate of the charging gun due to environmental conditions or faults in the electric vehicle charging station which leads to damage of the vehicle, vehicle battery, charging station and surroundings.

Hence, there is a need for an improved smart electric vehicle charging system and method for situational monitoring and alerting in order to address the aforementioned issues.

### BRIEF DESCRIPTION

In accordance with an embodiment of the disclosure, a smart electric vehicle charging system for situational monitoring and alerting is disclosed. The system includes a registration subsystem operable by one or more processors. The registration subsystem is configured to register one or more users on a platform upon receiving a plurality of user details from the one or more users. The system also includes a slot availability checking subsystem operable by the one or more processors. The slot availability checking subsystem is operatively coupled to the registration subsystem. The slot availability checking subsystem is configured to check an availability of at least one parking slot for electric vehicle charging for the one or more users on the platform by using one or more sensors. The system also includes a slot booking subsystem operable by the one or more processors. The slot booking subsystem is operatively coupled to the slot availability checking subsystem. The slot booking subsystem is configured to enable the one or more users to reserve a parking slot for an electric vehicle based on the availability of at least one parking slot. The system also includes an analysis subsystem operable by the one or more processors. The analysis subsystem is operatively coupled to the slot booking subsystem. The analysis subsystem is configured to analyse data associated with one of an image capturing device or a measuring device using an analysis technique. The system also includes a controlling subsystem operable by the one or more processors. The controlling subsystem is operatively coupled to the analysis subsystem. The controlling subsystem is configured to control one or more parameters associated with the electric vehicle charging station by a management unit on a server.

In accordance with another embodiment, a smart electric vehicle charging method for situational monitoring and alerting is disclosed. The method includes registering one or more users on a platform upon receiving a plurality of user details from the one or more users. The method also includes checking an availability of at least one parking slot for electric vehicle charging for the one or more users on the platform by using one or more sensors. The method also includes enabling the one or more users to reserve a parking slot for an electric vehicle based on the availability of the at least one parking slot. The method also includes analysing data associated with one of an image capturing device or a measuring device using an analysis technique. The method also includes controlling one or more parameters associated with the electric vehicle charging station by a management unit on a server.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a smart electric vehicle charging system for situational monitoring and alerting in accordance with an embodiment of the present disclosure;

FIG. 2 is a block diagram of an embodiment of the smart electric vehicle charging system for situational monitoring and alerting of FIG. 1 in accordance with an embodiment of the present disclosure;

FIG. 3 is a block diagram of a general computer system in accordance with an embodiment of the present disclosure; and

FIG. 4 is a flow diagram representing steps involved in a smart electric vehicle charging method for situational monitoring and alerting in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a smart electric vehicle charging system and method for situational monitoring and alerting. The system includes a registration subsystem operable by one or more processors. The registration subsystem is configured to register one or more users on a platform upon receiving a plurality of user details from the one or more users. The system also includes a slot availability checking subsystem operable by the one or more processors. The slot availability checking subsystem is operatively coupled to the registration subsystem. The slot availability checking subsystem is configured to check an availability of at least one parking slot for electric vehicle charging for the one or more users on the platform by using one or more sensors. The system also includes a slot booking subsystem operable by the one or more processors. The slot booking subsystem is operatively coupled to the slot availability checking subsystem. The slot booking subsystem is configured to enable the one or more users to reserve a parking slot for an electric vehicle based on the availability of the at least one parking slot. The system also includes an analysis subsystem operable by the one or more processors. The analysis subsystem is operatively coupled to the slot booking subsystem. The analysis subsystem is configured to analyse data associated with one of an image capturing device or a measuring device using an analysis technique. The system also includes a controlling subsystem operable by the one or more processors. The controlling subsystem is operatively coupled to the analysis subsystem. The controlling subsystem is configured to control one or more parameters associated with the electric vehicle charging station by a management unit on a server.

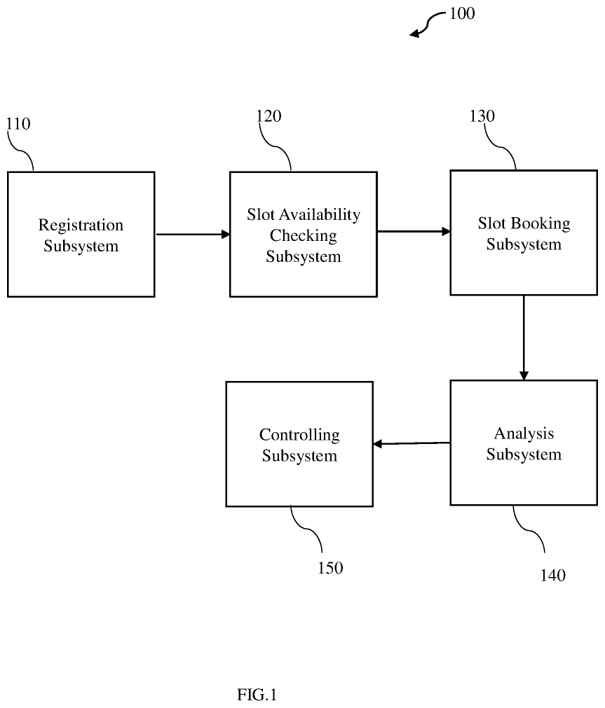

FIG. 1 is a block diagram representation of a smart electric vehicle charging system (100) for situational monitoring and alerting in accordance with an embodiment of the present disclosure. As used herein, the term ‘an electric vehicle’ is defined as a vehicle which uses one or more electric motors or traction motors for propulsion. In one embodiment, the electric vehicle may include one of an electric scooter, an electric car, an electric van, an electric light truck, an electric heavy truck and the like.

In one exemplary embodiment, the electric vehicle may be charged at a slow charging rate or at a fast charging rate by the electric charging station with the use of one or more outputs means such as, but not limited to, cables, plugs, sockets, connectors of alternating current (AC) power and direct current (DC) power. Further, the system (100) includes a registration subsystem (110) operable by one or more processors. The registration subsystem (110) is configured to register one or more users on a platform upon receiving a plurality of user details from the one or more users.

In one embodiment, the plurality of user details may include one or more user personal details and one or more user electric vehicle details. In some embodiment, the one or more user personal details may include, but not limited to, a user mobile number, a name and an image of the user. In one embodiment, the one or more user electric vehicle details may include, but not limited to, an electric vehicle license plate number, a make and model of the electric vehicle and the like.

In one exemplary embodiment, the one or more users may register with the platform via a user computing device such as a hand-held device or a portable device. In such embodiment, the user computing device may be one of a mobile phone, a laptop, a tablet and a desktop. Further, the system (100) may include a data storage subsystem configured to store the one or more user personal details and the one or more user electric vehicle details in a database, wherein the database is associated with the electric vehicle charging station.

Furthermore, the system (100) also includes a slot availability checking subsystem (120) operable by the one or more processors. The slot availability checking subsystem (120) is operatively coupled to the registration subsystem (110). The slot availability checking subsystem (120) is configured to check an availability of at least one parking slot for electric vehicle charging for the one or more users on the platform by using one or more sensors. In one embodiment, the one or more sensors may include a proximity sensor. As used herein, the term “proximity sensor” is used to detect presence of an object. In such embodiment, the proximity sensor may include, but not limited to, ultrasonic sensors, capacitive sensors, photoelectric sensors, inductive sensors or magnetic sensors.

In one embodiment, the electric vehicle charging station may be integrated with one or more image capturing devices, wherein the one or more image capturing devices may be configured to capture one or more images or videos of the electric vehicle charging station continuously.

In some embodiment, the one or more image capturing devices integrated with the electric charging station may be configured to work as a standard surveillance closed circuit television (CCTV) system, recording video and transmits the footage continuously based on the requirement. In one exemplary embodiment, the electric vehicle charging station may be configured to send and receive information from the surrounding surveillance systems to achieve some functionality.

Further, the slot availability checking subsystem (120) may be configured to check the availability of the at least one parking slot by analysing one or more captured images or videos of the electric vehicle charging station, wherein the analysis may be done by a processor. Further, the system (100) may include a notification transmission subsystem configured to send a real-time analysed result on a server via a wireless communication module such as second generation (2G) cellular technology, third generation (3G) cellular technology, fourth generation (4G) cellular technology, fifth generation (5G) cellular technology, narrow band-internet of thing (NB-IoT) or a radio frequency (RF) transceiver, wherein the radio frequency transceiver may include, but not limited to Lora, Zigbee and the like.

As used herein, the term “radio frequency trans receiver” is defined as a small electronic device used to transmit or receive radio signals between two devices. In such embodiment, the wireless communication module may include, but not limited to, a wireless fidelity, Bluetooth®, a local area network (LAN), a narrowband internet of things (IoT) and the like. As used herein, the term “narrowband IoT” is a low power wide area network (LPWAN) radio technology to enable a wide range of cellular devices and services.

In one embodiment, the server may be connected to the electric vehicle charging station. In one embodiment, the server may include, but not limited to, a cloud server, a plurality of charging stations and the like. As used herein, the term “cloud server” is a logical server that is built, hosted and delivered through a cloud computing platform over the internet. In one embodiment, the electric vehicle charging station may use a plurality of communication protocols to communicate with the server such as, but not limited to, an open charge point protocol (OCPP) 1.6, an OCPP 2.0 and the like.

Further, the notification transmission subsystem may be configured to send the real-time analysed result from the server to the user platform. In another embodiment, the notification transmission subsystem may display the real-time analysed result on a display device associated with the electric vehicle charging station to the one or more users. In such embodiment, the display device may include, but not limited to a light emitting diode (LED), a web dashboard and the like. In one embodiment, the display device may be controlled by the processor.

The system (100) also includes a slot booking subsystem (130) operable by the one or more processors. The slot booking subsystem (130) is operatively coupled to the slot availability checking subsystem (120). Further, the slot booking subsystem (130) is configured to enable the one or more users to reserve a parking slot for the electric vehicle when the real time analysed result shows the availability of the at least one parking slot.

In one embodiment, the system (100) may include a monitoring subsystem operatively coupled to the slot booking subsystem (130). The monitoring subsystem is configured to monitor data associated with the electric vehicle and the electric vehicle charging station using the one or more image capturing devices. In one embodiment, the data may include, but not limited to, the electric vehicle licence plate number, an authentication of the user, an authorization of the electric vehicle and the make and model of the electric vehicle.

Further, the system (100) also includes an analysis subsystem (140) operable by the one or more processors. The analysis subsystem (140) is operatively coupled to the monitoring subsystem. The analysis subsystem (140) is configured to analyse data associated with one of an image capturing device or a measuring device using an analysis technique, wherein the image capturing device may be configured to capture one or more images or videos, wherein the one or more captured images or videos is associated with the electric vehicle, the electric vehicle charging station and a combination thereof.

In one embodiment, the analysis technique may include a computer vision technique. As used herein, the term “computer vision technique” is a field of artificial intelligence that train machines to interpret and understand the visual world. Also, the computer vision technique is used for identifying objects in the images or videos.

Further, in one exemplary embodiment, the analysis subsystem (140) may be configured to analyse the electric vehicle licence plate number from the one or more captured images or videos by using the computer vision technique. In such embodiment, the computer vision technique may be configured to first detect one or more text regions using one or more feature detection techniques. In such embodiment, the one or more feature detection techniques may include, but not limited to, gradient based features, histograms of oriented gradients (HOG) and the like.

Further, the computer vision technique may be configured to eliminate one or more non text regions using one of a machine learning or geometric features. Furthermore, one or more detected text regions may be grouped together to form a single connected segmented region. Then, one of an object recognition technique may be used to detect a licence number written on the plate of the electric vehicle. In one embodiment, the one of object recognition technique may include a tesscract object recognition technique (OCR).

Furthermore, the system (100) may include a verification subsystem configured to verify a detected electric vehicle licence plate number with a stored licence plate number of the corresponding electric vehicle. Similarly, in one embodiment, the analysis subsystem (140) may be configured to analyse a user face from the one or more captured images or videos using the computer vision technique. In such embodiment, the computer vision technique may include a face detection algorithm.

In one embodiment, the face detection algorithm may be configured to locate presence and location of face in the one or more captured images or videos. Further, a plurality of features may be extracted from one or more detected faces using a convolutional neural network. Further, the verification subsystem may be configured to verify the one or more detected faces by matching a plurality of extracted features with the plurality of features associated with the user face stored in the database.

Further, the analysis subsystem (140) may be configured to analyse the electric vehicle to identify the make and model of the electric vehicle from the one or more captured images or videos using the analysis technique. The verification subsystem may be configured to verify the make and model of the vehicle by comparing the images or videos with the images of vehicles stored in the database by using a computer vision technique to read the vehicle manufacturer name and model. Furthermore, the notification transmission subsystem may be configured to send information associated with the make and model of the electric vehicle on the server.

In one embodiment, the system (100) may also include an estimation subsystem operatively coupled to the notification transmission subsystem. The estimation subsystem may be configured to estimate the charging time required for the corresponding electric vehicle by a management unit on the server upon receiving the information associated with the make and model of the electric vehicle.

In some embodiment, the system (100) may include a payment generation subsystem operatively coupled to the estimation subsystem. The payment generation subsystem may be configured to compute a cost for the charging service availed by the one or more users upon verifying the licence plate number of the corresponding electric vehicle and owner of the electric vehicle.

In one embodiment, the analysis subsystem (140) may be configured to analyse the one or more captured images or videos to check the authorization of the vehicle which is parked in front of the electric vehicle charging station. In one embodiment, the authorization of the vehicle may include a category of the vehicle, wherein the category of the vehicle may include, but not limited to, the electric vehicle, a non-electric vehicle and the like.

Further, the analysis subsystem (140) may be configured to check the category of the vehicle by first detecting the color of the vehicle licence plate for identifying the difference between the electric vehicle and the non-electric vehicle. Further, the licence plate number may be matched against the stored licence plate number to validate the authorization of the electric vehicle.

Furthermore, the notification transmission subsystem may be configured to send information associated with the unauthorized vehicle on the server for taking an appropriate action by the management unit. In some embodiment, the analysis subsystem (140) may also be configured to analyse the one or more captured images or videos to identify the presence of the electric vehicle in front of the charging station even if the charging of the parked electric vehicle is completed. Then, the notification transmission subsystem may be configured to notify the one or more users to remove a charging connector from the electric vehicle.

The system (100) also includes a controlling subsystem (150) operable by the one or more processors. The controlling subsystem (150) is operatively coupled to the analysis subsystem (140). The controlling subsystem (150) is configured to control one or more parameters associated with the electric vehicle charging station by the management unit on the server. In one embodiment, the one or more parameters may include, but not limited to, energy distribution over electric vehicles based on the required power and energy, tampering attempts and the like.

In one embodiment, the analysis subsystem (140) may be configured to keep track of input and output voltage, current and power distributed over the electric vehicles using the measuring device, wherein the measuring device may include an energy meter, signal detection and like. As used herein, the term “energy meter” is defined as a meter which is used for measuring the energy utilises by the electric load.

Further, the notification transmission subsystem may be configured to send information associated with energy distribution on the server, where the controlling subsystem (150) may be configured to enable the management unit to optimize the energy distribution over the electric vehicles by using one of a relays or contactors based on the requirement of power and energy. As used herein, the term “relays” is defined as an electrically operated or electromechanical switch composed of an electromagnet, an armature, a spring and a set of electrical contacts. Also, as used herein, the term “contractor” is defined as an electrically controlled switch used for switching an electrical power circuit.

In some embodiment, the analysis subsystem (140) may be configured to analyse the one or more captured images or videos and other techniques or control signals generated and measured by the processor(s) to identify the tampering attempts such as, but not limited to, enclosure opening, physical damage of charging wire, disconnected state of the wire or cable. In one embodiment, the verification subsystem may be configured to identify the tampering attempts by using the computer vision technique. In such embodiment, the charging station enclosure includes a switch configured to generate an alert when the enclosure is opened. In some embodiment, the charging wire may also be monitored by a two-way signal which is sent from the processor. Further, the damaged state of the charging wire is identified upon monitoring any deviation in receiving the signal.

Furthermore, the notification transmission subsystem may be configured to send identified tampering attempts to the server along with the video evidence to take some action.

Further, in some embodiment, the system (100) may include a problem identification subsystem operatively coupled to the analysis subsystem (140). The problem identification subsystem may be configured to identify one or more problems associated with a charging of the electric vehicle based on the analysed result, wherein the one or more problems may include, but not limited to, headlight or taillight remains turned on while charging the electric vehicle, improper connection of charging gun with the electric vehicle, sudden increased or decreased charging rate of the charging gun and the like.

In one embodiment, the system (100) may include a problem monitoring subsystem operatively coupled to the problem identification subsystem. The problem monitoring subsystem may be configured to control one or more identified problems associated with the charging of the electric vehicle by at least one user upon receiving notification from the server.

In one embodiment, the problem identification subsystem may be configured to identify status of headlights, taillights or indicators while connected to the charging source from the one or more captured images or videos. In such embodiment, the notification transmission subsystem may be configured to send status of the headlights, taillights or indicators on the server. Further, the problem monitoring subsystem may be configured to notify the one or more users to turn off the at least one of the headlight, taillight or indicator when the status of at least one of the headlights, taillights or indicators is turned on.

Further, in some embodiment, the problem identification subsystem may be configured to identify the connection of a charging gun with the electric vehicle by analysing the one or more captured images or videos. In another embodiment, the problem identification subsystem may be configured to identify the connection of a charging gun with the electric vehicle by detecting the connectivity between the charging connector and the vehicle through a signal sent by the processor(s). The notification transmission subsystem may be configured to send a notification on the server when the connection of the charging gun is not established. Further, the problem monitoring subsystem may be configured to send the notification to the one or more users to connect the charging gun with the electric vehicle in a correct manner.

In some embodiment, the problem identification subsystem may be configured to check the charging rate associated with the charging gun while charging the electric vehicle by analysing the data from the integrated energy meter in the charging station, which measures voltage and current among other variables. In one embodiment, the variation of the charging rate may depend upon the variation of environmental conditions. In such embodiment, the environmental conditions may include, but not limited to, ambient temperature, humidity temperature and the like. In some embodiment, the environmental conditions may be checked by using one or more environmental sensors. Further, the notification transmission subsystem may be configured to send data associated with the charging rate on the server.

Further, the problem monitoring subsystem may be configured to send a notification to the one or more users for enabling the one or more users to decide whether to charge further when the electric vehicle battery reaches a certain threshold value.

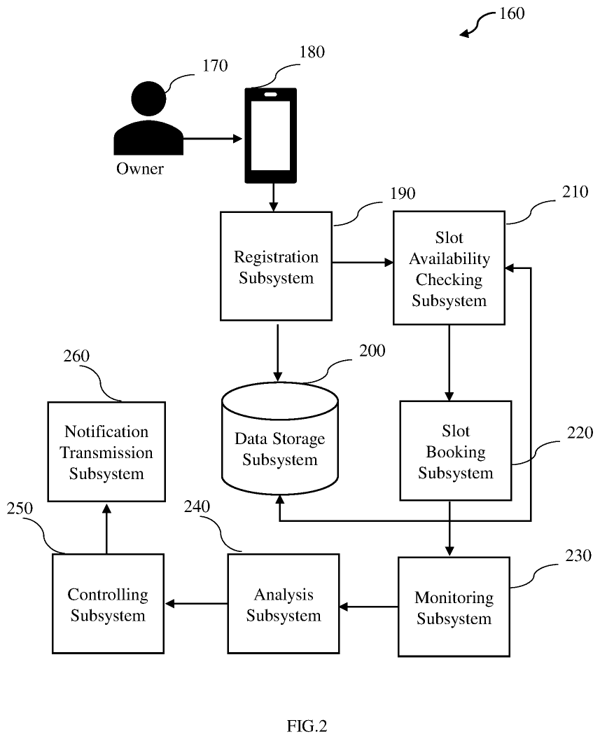

FIG. 2 is a block diagram of an embodiment of the smart electric vehicle charging system (160) for situational monitoring and alerting of FIG. 1 in accordance with an embodiment of the present disclosure. An owner (170) of an electric car registers on a platform by a registration subsystem (190) through an owner device (180) upon providing a plurality of details including owner name, one or more owner personal details and one or more details associated with the electric car. Further, the plurality of details is stored in a database by a data storage subsystem (200).

Upon registration of the owner (170), an availability of at least one charging slot is checked in the surrounding area or the area as desired by the owner, by a slot availability checking subsystem (210), using a proximity sensor. Further, as the owner (170) receives a notification about the availability of at least one charging slot for charging the electric car, the slot booking subsystem (220) enables the owner (170) to reserve the available charging slot for the electric car through the owner device (180).

Furthermore, upon arriving the electric car at the electric vehicle charging station, the monitoring subsystem (230) monitors the electric car and the electric vehicle charging station using one or more cameras, wherein the one or more cameras may be installed at different places at the electric vehicle charging station.

Upon monitoring the electric car and the electric vehicle charging station, the analysis subsystem (240) verifies the owner (170) and licence plate number of the electric car by comparing the user personal details and one or more details associated with the electric car against the one or more owner details stored in the database to initiate charging of the electric car.

Also, the analysis subsystem (240) identifies the make and model of the electric car for determining the approximate charge time required for the electric car. Moreover, the energy distribution over the electric car is controlled by the controlling subsystem (250) using relays. Upon verification and identification, a notification transmission subsystem (260) sends the verified information on the server for generating a bill based on the electricity consumed by the owner (170).

Furthermore, the registration subsystem (190), the slot availability checking subsystem (210), the slot booking subsystem (220), the analysis subsystem (240) and the controlling subsystem (250) are substantially similar to a registration subsystem (110), a slot availability checking subsystem (120), a slot booking subsystem (130), an analysis subsystem (140) and a controlling subsystem (150) of FIG. 1.

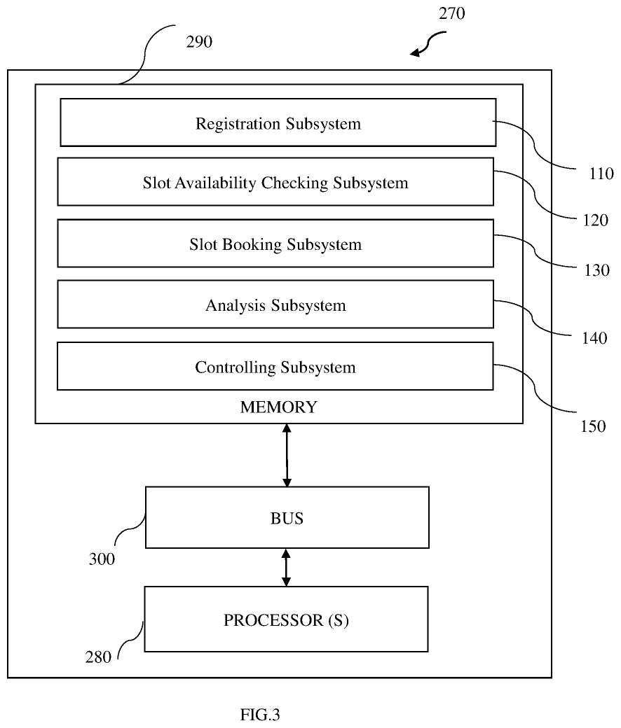

FIG. 3 is a block diagram of a general computer system (270) in accordance with an embodiment of the present disclosure. The computer system (270) includes processor(s) (280), and memory (290) coupled to the processor(s) (280) via a bus (300).

The processor(s) (280), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (290) includes a plurality of units stored in the form of executable program which instructs the processor (280) to perform the configuration of the system illustrated in FIG. 1. The memory (290) has following subsystems: a registration subsystem (110), a slot availability checking subsystem (120), a slot booking subsystem (130), an analysis subsystem (140) and a controlling subsystem (150) of FIG. 1.

Computer memory elements may include any suitable memory device(s) for storing data and executable program, such as read-only memory, random access memory, erasable programmable read-only memory, electrically erasable programmable read- only memory, hard drive, removable media drive for handling memory cards and the like. Embodiments of the present subject matter may be implemented in conjunction with program subsystems, including functions, procedures, data structures, and application programs, for performing tasks, or defining abstract data types or low-level hardware contexts. The executable program stored on any of the above-mentioned storage media may be executable by the processor(s) (280).

The registration subsystem (110) instructs the processor(s) (280) to register one or more users on a platform upon receiving a plurality of user details from the one or more users.

The slot availability checking subsystem (120) instructs the processor(s) (280) to check an availability of at least one charging slot for the one or more users using one or more sensors upon registration of the one or more users on the platform.

The slot booking subsystem (130) instructs the processor(s) (280) to enable the one or more users to reserve a charging slot for an electric vehicle based on the availability of the at least one charging slot.

The analysis subsystem (140) instructs the processor(s) (280) to analyse data associated with one of an image capturing device or a measuring device using an analysis technique.

The controlling subsystem (150) instructs the processor(s) (280) to control one or more parameters associated with the electric vehicle charging station by a management unit on a server.

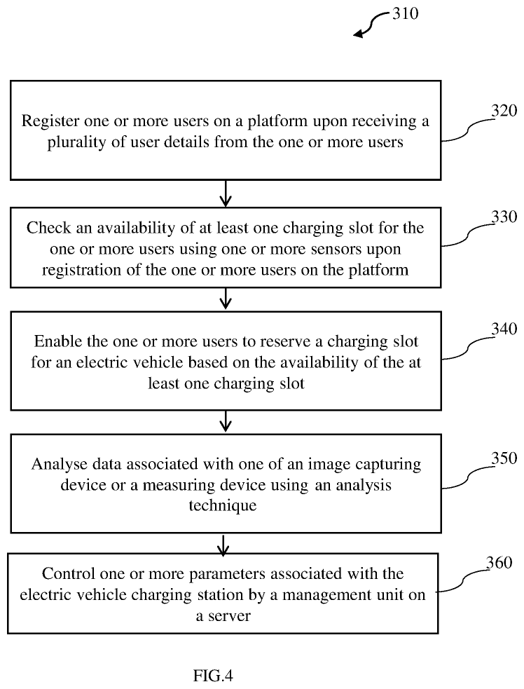

FIG. 4 is a flow diagram representing steps involved in a smart electric vehicle charging method (310) for situational monitoring and alerting in accordance with an embodiment of the present disclosure. The method (310) includes registering, by a registration subsystem, one or more users on a platform upon receiving a plurality of user details from the one or more users in step 320. In one embodiment, registering the one or more users on the platform upon receiving the plurality of user details from the one or more users may include registering the one or more users on the platform upon receiving one or more user personal details and one or more user electric vehicle details from the one or more users.

Further, in such embodiment, registering the one or more users on the platform upon receiving one or more user personal details may include registering the one or more users on the platform upon receiving a user mobile number, a name, an image of the user and the like. In one embodiment, registering the one or more users on the platform upon receiving one or more user electric vehicle details may include registering the one or more users on the platform upon receiving a vehicle license plate number, a make and model of the electric vehicle and the like.

In one embodiment, the method (310) may include storing, by a data storage subsystem, the one or more user personal details and the one or more user electric vehicle details in a database, wherein the database is associated with the electric vehicle charging station. Further, the method (310) also includes checking, by a slot availability checking subsystem, an availability of at least parking slot for electric vehicle charging for the one or more users on the platform by using one or more sensors in step 330. In one embodiment, checking the availability of the at least one parking slot for the one or more users using the one or more sensors may include checking the availability of the at least one parking slot for the one or more users using a proximity sensor.

Further, in one embodiment, the method (310) may include checking the availability of the at least one parking slot by analysing the one or more captured images or videos of the electric vehicle charging station, wherein the analysis may be done by a processor. In some embodiment, the method (310) may include sending, by a notification transmission subsystem, a real-time analysed result on a server via a wireless communication module such as second generation (2G) cellular technology, third generation (3G) cellular technology, fourth generation (4G) cellular technology, fifth generation (5G) cellular technology, narrow band-internet of thing (NB-IoT) or a radio frequency (RF) transceiver, wherein the radio frequency transceiver may include, but not limited to Lora, Zigbee and the like.

In such embodiment, sending the real-time analysed result on the server via the wireless communication module may include sending the real-time analysed result on the server via one of a wireless fidelity, Bluetooth(, local area network (LAN), narrowband internet of things (IoT) and the like.

In one embodiment, the method (310) may include sending, by the notification transmission subsystem, the real-time analysed result from the server to the user platform. In another embodiment, the method (310) may include displaying the real-time analysed result on a display device associated with the electric vehicle charging station to the one or more users.

Further, the method (310) includes enabling, by a slot booking subsystem, the one or more users to reserve a charging slot for the electric vehicle when the real time analysed result shows the availability of the at least one charging slot in step 340. In one embodiment, the method (310) may include monitoring, by a monitoring subsystem, data associated with the electric vehicle and the electric vehicle charging station using the one or more image capturing devices. In one embodiment, monitoring the data associated with the electric vehicle and the electric vehicle charging station may include monitoring the electric vehicle licence plate number, an authentication of the user, an authorization of the electric vehicle and the make and model of the electric vehicle.

The method (310) includes analysing, by an analysis subsystem, data associated with one of an image capturing device or a measuring device using an analysis technique in step 350, wherein the image capturing device captures one or more images or videos, wherein the one or more captured images or videos are associated with the electric vehicle, the electric vehicle charging station and a combination thereof. In one embodiment, analysing the data associated with the one or more captured images or videos using the analysis technique may include analysing the data associated with the one or more captured images or videos using a computer vision technique.

Further, in one embodiment, the method (310) may include analysing the electric vehicle licence plate number from the one or more captured images or videos by using the computer vision technique. In such embodiment, the method (310) may include detecting, by the computer vision technique, one or more text regions using one or more feature detection techniques.

Further, in one embodiment, the method (310) may include eliminating one or more non text regions using one of a machine learning or geometric features. In some embodiment, the method (310) may include grouping together one or more detected text regions to form a single connected segmented region. Afterwards, the method (310) may include detecting the licence number written on the plate of the electric vehicle by using one of an object recognition technique.

Further, in one exemplary embodiment, the method (310) may also include verifying, by a verification subsystem, a detected electric vehicle licence plate number with a stored licence plate number of the corresponding electric vehicle. In one embodiment, the method (310) may include analysing, by the analysis subsystem, a user face from the one or more captured images or videos using the computer vision technique. In such embodiment, analysing the user face from the one or more captured images or videos using the computer vision technique may include analysing the user face from the one or more captured images or videos using a face detection algorithm.

In one embodiment, the method (310) may include locating, by the face detection algorithm, the presence and location of face in the one or more captured images or videos. In some embodiment, the method (310) may include extracting a plurality of features from one or more detected faces using a convolutional neural network.

Further, the method (310) may include verifying, by the verification subsystem, the one or more detected faces by matching a plurality of extracted features with the plurality of features associated with the user face stored in the database. In one embodiment, the method (310) may also include analysing, by the analysis subsystem, the electric vehicle to identify the make and model of the electric vehicle from the one or more captured images or videos using the analysis technique. Further, the method may include verifying, by the verification subsystem, the make and model of the vehicle by comparing the images or videos to images of vehicles stored in the database by using a computer vision technique to read the vehicle manufacturer name and model.

In some embodiment, the method (310) may include sending, by the notification transmission subsystem, information associated with the make and model of the electric vehicle on the server. Further, the method (310) may include estimating, by an estimation subsystem, the charging time required for the corresponding electric vehicle by a management unit on the server upon receiving the information associated with the make and model of the electric vehicle.

In one exemplary embodiment, the method (310) may include computing, by a payment generation subsystem, a cost for the charging service availed by the one or more users upon verifying the licence plate number of the corresponding electric vehicle and owner of the electric vehicle.

In some embodiment, the method (310) may include analysing, by the analysis subsystem, the one or more captured images or videos to check the authorization of the vehicle which is parked in front of the charging station. In such embodiment, the method (310) may include checking the authorization of the vehicle may include checking a category of the vehicle, wherein the category of the vehicle may include, but not limited to, the electric vehicle, a non-electric vehicle and the like.

In one embodiment, checking the category of the vehicle may include checking the category of the vehicle by first detecting the color of the vehicle licence plate for identifying the difference between electric vehicle and non-electric vehicle and then the licence plate number may be matched against the stored licence plate number to validate the authorization of the electric vehicle.

In some embodiment, the method (310) may include sending, by the notification transmission subsystem, information associated with the unauthorized electric vehicle on the server for taking an appropriate action by the management unit. The method (310) may include analysing the one or more captured images or videos to identify the presence of the electric vehicle in front of the charging station even if the charging of the parked electric vehicle is completed. Further, in one embodiment, the method (310) may include sending the notification to the one or more users to remove a charging connector from the electric vehicle.

Furthermore, the method (310) also includes controlling, by a controlling unit, one or more parameters associated with the electric vehicle charging station by the management unit on the server in step 360. In one embodiment, controlling the more parameters associated with the electric vehicle charging station may include controlling energy distribution over electric vehicles based on the required power and energy, tampering attempts and the like.

Further, in one embodiment, the method (310) may include keeping track, by the analysis subsystem, of input and output voltage, current and power distributed over the electric vehicles using the measuring device, wherein the measuring device may include an energy meter, signal detection and like. In one embodiment, the method (310) may also include sending, by the notification transmission subsystem, information associated with energy distribution on the server, where the controlling subsystem may optimize the energy distribution over the electric vehicles by using one of a relays or contactors based on the requirement of power and energy.

In some embodiment, the method (310) may include analysing, by the analysis subsystem, the one or more captured images or videos or control signals generated and measured by the processor(s) to identify the tampering attempts such as, but not limited to, enclosure opening, physical damage of wire, disconnected state of the wire or cable. Further, the method (310) may include sending identified tampering attempts on the server along with the video evidence to take some action.

In some embodiment, the method (310) may include identifying, by a problem identification subsystem, one or more problems associated with a charging of the electric vehicle based on the analysed result. Further, the method (310) may include controlling, by a problem monitoring subsystem, one or more identified problems associated with the charging of the electric vehicle by at least one user upon receiving notification from the server.

Further, the method (310) may include identifying, by the problem identification subsystem, status of headlights, taillights or indicators while connected to the charging source from the one or more captured images or videos. The method (310) may include notifying the one or more users to turn off the at least one of the headlight, taillight or indicator when the status of at least one of the headlights, taillights or indicators is turned on upon receiving notification from the server.

In some embodiment, the method (310) may include identifying the connection of a charging gun with the electric vehicle by analysing the one or more captured images, video or through the signals generated and received by the processor(s). Further, in some embodiment, the method (310) may include sending, by the problem monitoring subsystem, the notification to the one or more users to connect the charging gun with the electric vehicle in a correct manner.

In one embodiment, the method (310) may also include identifying, by the problem identification subsystem, the charging rate associated with the charging gun while charging the electric vehicle by analysing the data from the integrated energy meter in the charging station, which measures voltage and current among other variables. Then, in some embodiment, the method (310) may include sending, by the problem monitoring subsystem, a notification to the user for enabling the user to decide whether to charge further when the electric vehicle battery reaches a certain threshold value.

Various embodiments of the present disclosure provide information about already parked electric vehicle at the electric vehicle charging station by using one or more sensors. Moreover, the system eliminates the need of human intervention to check if an unauthorized person parks in front of the electric vehicle charging station by analysing the one or more captured images or videos. Further, the system eliminates the manual verification of the user by verifying the user with the existing image of the user from the database upon capturing one or more images or videos.

Furthermore, the system also notifies the user if any one of the headlight, taillight or indicator of the electric vehicle remains turned on while charging the electric vehicle by analysing the one or more captured images or videos. Also, the present invention identifies if the charging gun is not plugged in properly by analysing the one or more captured images, videos or by analysing the signals generated and received by the processor(s) and notifies the user to plug-in properly. Furthermore, the present invention generates an alert for the user to decide whether to charge further or not, when the battery of the electric vehicle reaches a certain threshold value.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A smart electric vehicle charging system (100) for situational monitoring and alerting comprising:
a registration subsystem (110) operable by one or more processors, wherein the registration subsystem (110) is configured to register one or more users on a platform upon receiving a plurality of user details from the one or more users;
a slot availability checking subsystem (120) operable by the one or more processors, wherein the slot availability checking subsystem (120) is operatively coupled to the registration subsystem (110), wherein the slot availability checking subsystem (120) is configured to check an availability of at least one charging slot for the one or more users using one or more sensors upon registration of the one or more users on the platform;
a slot booking subsystem (130) operable by the one or more processors, wherein the slot booking subsystem (130) is operatively coupled to the slot availability checking subsystem (120), wherein the slot booking subsystem (130) is configured to enable the one or more users to reserve a charging slot for an electric vehicle based on the availability of the at least one charging slot;
an analysis subsystem (140) operable by the one or more processors, wherein the analysis subsystem (140) is operatively coupled to the slot booking subsystem (130), wherein the analysis subsystem (140) is configured to:
analyse data associated with one of an image capturing device or a measuring device using an analysis technique; and
a controlling subsystem (150) operable by the one or more processors, wherein the controlling subsystem (150) is operatively coupled to the analysis subsystem (140), wherein the controlling subsystem (150) is configured to control one or more parameters associated with the electric vehicle charging station by a management unit on a server.

2. The system (100) as claimed in claim 1, wherein the image capturing device is configured to capture one or more images or videos, wherein the one or more captured images or videos are associated with the electric vehicle, the electric vehicle charging station and a combination thereof.

3. The system (100) as claimed in claim 1, wherein the data comprises a vehicle licence plate number, an authentication of the user, an authorization of the vehicle and a make and model of the electric vehicle.

4. The system (100) as claimed in claim 1, wherein the one or more parameters comprises the energy distribution over electric vehicles based on the required power and energy and tampering attempts.

5. The system (100) as claimed in claim 1, further comprising a problem identification subsystem configured to identify one or more problems associated with charging of the electric vehicle based on an analysed result, wherein the one or more problems comprises headlight or taillight remains turned on while charging the electric vehicle, improper connection of charging gun with the electric vehicle, sudden increased or decreased charging rate of the charging gun.

6. The system (100) as claimed in claim 1, further comprising a problem monitoring subsystem configured to control one or more identified problems associated with the charging of the electric vehicle by at least one user upon receiving notification from a server.

7. A smart electric vehicle charging method (310) for situational monitoring and alerting comprising:
registering, by a registration subsystem, one or more users on a platform upon receiving a plurality of user details from the one or more users; (320)
checking, by a slot availability checking subsystem, an availability of at least one charging slot for the one or more users using one or more sensors upon registration of the one or more users on the platform; (330)
enabling, by a slot booking subsystem, the one or more users to reserve a charging slot for an electric vehicle based on the availability of the at least one charging slot; (340)
analysing data associated with one of an image capturing device or a measuring device using an analysis technique; and (350)
controlling, by a controlling subsystem, one or more parameters associated with the electric vehicle charging station by a management unit on a server. (360)

8. The method (310) as claimed in claim 7, controlling the one or more parameters comprises controlling an energy distribution over electric vehicles based on the required power and energy and tampering attempts.

9. The method (310) as claimed in claim 7, further comprising identifying, by a problem identification subsystem, one or more problems associated with charging of the electric vehicle based on an analysed result, wherein the one or more problems comprises headlight or taillight remains turned on while charging the electric vehicle, improper connection of charging gun with the electric vehicle, sudden increased or decreased charging rate of the charging gun.

10. The method (310) as claimed in claim 7, controlling, by a problem monitoring subsystem, one or more identified problems associated with the charging of the electric vehicle by at least one user upon receiving notification from a server.
